(19) United States
(12) Patent Application Publication
(10) Pub. No.: US 2018/0070428 A1
(43) Pub. Date: Mar. 8, 2018

(54) CONTROL SYSTEM AND CONTROL METHOD FOR WIRELESS LAMP

(71) Applicant: Dan Huang, Shenzhen City (CN)

(72) Inventor: Dan Huang, Shenzhen City (CN)

(21) Appl. No.: 15/505,764

(22) PCT Filed: May 5, 2015
(86) PCT No.: PCT/CN2015/078298

§ 371 Date: Feb. 22, 2017

(51) Int. Cl. H05B 37/02; H05B 33/08

(52) U.S. Cl. CPC H05B 37/0272; H04R 2420/07; Y02B 20/48; H05B 33/0845

(57) ABSTRACT

Disclosed are a control system and a control method for a wireless lamp. The control system includes a wireless module (1) for a wireless pairing connection with a mobile device (a), a power supply module (2) connected between a power source (b) and a light-emitting body (c), and a microprocessor (3) for recognizing a signal input by the wireless module (1) and controlling turn-on or turn-off of the power supply module (2). The wireless module (1) and the power supply module (2) are respectively connected to the microprocessor (3). The mobile device (a) such as a smart mobile phone or a tablet computer is combined with the power supply module (2) to form a direct control relation by means of coprocessing of the microprocessor (3) and by way of a wireless connection. When a user holds the mobile device (a) and enables a corresponding wireless connection function within a sensing range of the wireless module (1), after a successful pairing, the microprocessor (3) can control the power supply module (2) to supply power to the light-emitting body (c), thereby realizing intelligent control of on-off function of the light-emitting body (c). The control system for a wireless lamp is simple in system structure, abundant in functions and convenient to control, and thus having a good practical value and a good market promotion value.

### TECHNICAL FIELD

The present disclosure relates to the field of lamp control, and in particular to a control system and a control method for a wireless lamp.

### BACKGROUND OF THE INVENTION

At present, control of lamps usually adopts two modes, namely a wired control mode and a wireless control mode. As the most conventional control mode, in the wired control mode, a switch is connected to a lamp through an electric wire, so that on-off control of the lamp is achieved by turning a power supply circuit on or off using the switch. However, this mode is cumbersome in installation and inconvenient to control. Taking household lighting lamps as an example, in cold days or when people are sleepy, people are reluctant to get out of bed to turn off the lamps, which may cause waste of electric power. Whereas, in the wireless control mode, on-off control of the lamp is achieved by means of a remote controller. Control of the lamp may be unachievable when the remote controller is lost or damaged. In addition, generally existing lamps are single in function and poor in energy-saving effect.

As science and information technologies are widely used, mobile devices (such as mobile phones, tablet computers and the like) gradually become indispensable to people's lives. Therefore, it is necessary to combine the mobile devices with the lamps to achieve intelligent control of the lamps and to enrich functions of the lamps.

### SUMMARY OF THE INVENTION

Directed at the above disadvantages in the prior art, an objective of the present disclosure is to provide a control system for a wireless lamp that is simple in system structure, abundant in functions, convenient to control and remarkable in energy-saving effect. Another objective of the present disclosure is to provide a control method for a wireless lamp that is simple in step, easy for implementation and convenient to operate.

In order to achieve the foregoing objectives, the present disclosure adopts the following technical solutions:

A control system for a wireless lamp includes a wireless module for wireless pairing connection with a mobile device, a power supply module connected between a power source and a light-emitting body, and a microprocessor for recognizing a signal input by the wireless module and controlling the power supply module to be turned on or off. The wireless module and the power supply module are respectively connected to the microprocessor. The wireless module is a Bluetooth module or a WIFI module.

Preferably, the power supply module is a dimmer.

Preferably, the microprocessor is further connected with a first code switch for controlling the microprocessor to output a PWM modulated signal to the dimmer.

Preferably, the microprocessor is further connected with a clock module for controlling the dimmer to be turned on/off on time by means of the microprocessor.

Preferably, an output end of the microprocessor is connected with a Bluetooth speaker by means of an audio amplifier, and an input end thereof is connected with an FM radio receiver.

Preferably, the microprocessor is further connected with a second code switch for controlling volume level of the Bluetooth speaker by means of the microprocessor.

Preferably, the microprocessor is further connected with a display screen.

A control method for a wireless lamp includes following steps:

Step I, a wireless pairing connection with a mobile device is carried out by means of a wireless module.

Step II, after recognizing a signal indicating successful pairing of the wireless module, the microprocessor controls a power supply module to be turned on, or otherwise controls the power supply module to be turned off.

Preferably, an APP is embedded into the mobile device in advance, and the microprocessor receives a control instruction issued by the APP by means of the wireless module and synchronously uploads data information.

Preferably, the mobile device is a smart mobile phone, a tablet computer or a smart wearable device.

Since the above solutions are adopted, by means of coprocessing of the microprocessor, the present disclosure combines a mobile device such as a smart mobile phone or a tablet computer and the like with a power supply module to form a direct control relation by way of the wireless connection. When a user holds the mobile device and enables a corresponding wireless connection function within a sensing range of a wireless module, after a successful pairing, the microprocessor can control the power supply module to supply power to a light-emitting body, thereby realizing the intelligent control of on-off function of the light-emitting body. The control system for a wireless lamp is simple in system structure, abundant in functions and convenient to control, and thus having a good practical value and a good market promotion value.

### BRIEF DESCRIPTION OF THE DRAWING

FIG. 1 is a schematic control block diagram according to embodiments of the present disclosure.

### DETAILED DESCRIPTION OF THE PREFERRED EMBODIMENTS

The embodiments of the present disclosure will be described in detail with reference to the accompanying drawings. However, the present disclosure can be implemented by a plurality of different embodiments limited and covered by claims.

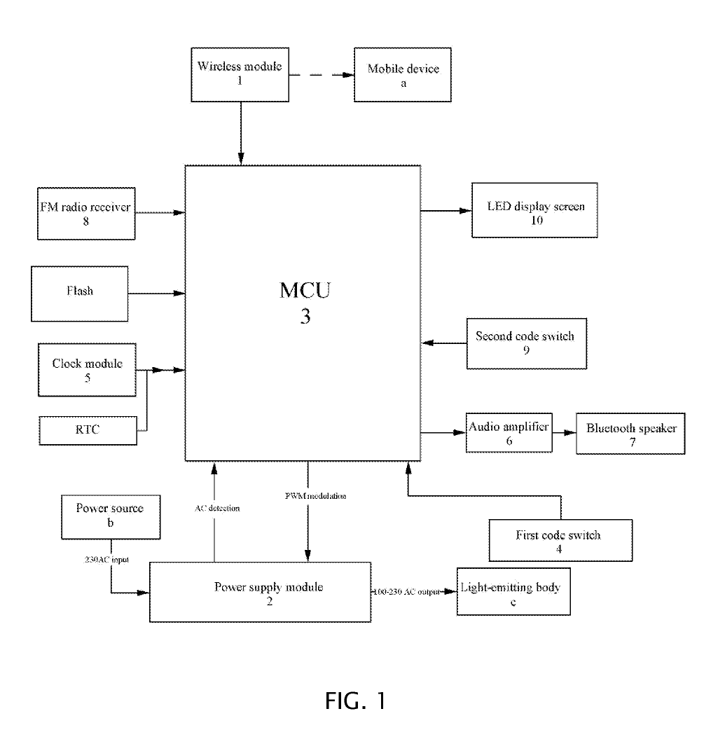

As shown in FIG. 1, this embodiment provides a control system for a wireless lamp, which includes a wireless module 1 (in this embodiment, the wireless module 1 can be a Bluetooth module or a WIFI module preferably adopted according to specific conditions) for a wireless pairing connection with a mobile device a (for example, a smart mobile phone, a tablet computer or a smart wearable device having a wireless connection function such as Bluetooth or WIFI), a power supply module 2 connected between a power source b and a light-emitting body c, and a microprocessor 3 for recognizing a signal input by the wireless module 1 and controlling turn-on or turn-off of the power supply module 2 according to a data signal of the wireless module 1. The wireless module 1 and the power supply module 2 are respectively connected to the microprocessor 3. In this way, the mobile device a is combined with the power supply module 2 to form a direct control relation by means of coprocessing of the microprocessor 3 and by way of the wireless connection. When a user holds the mobile device a and enables a corresponding wireless connection function within a sensing range of the wireless module 1, after successful pairing, the microprocessor 3 can control the power supply module 2 to supply power to the light-emitting body c. When the user wants to turn the lamp off, the user only needs to disable the wireless connection function of the mobile device a. The microprocessor 3 recognizes that the wireless module 1 has no wireless pairing connection and controls the power supply module 2 to interrupt power supply so that the light-emitting body c or the whole lamp is turned off. Wide popularization of the smart mobile phone and the tablet computer or the like will greatly facilitate the control of the lamp in this embodiment. Furthermore, the lamp can be automatically turned off when it is not in use, and thus the control system for a wireless lamp has an effect of energy conservation and environmental protection.

To ensure the compatibility of the whole control system and improve the effect of energy conservation and environment protection, the power supply module 2 of this embodiment adopts a dimmer. After the microprocessor 3 recognizes a signal indicating successful pairing, a PWM modulated signal is output to the dimmer by detecting an input voltage of the dimmer, thus voltage regulation is achieved by adjusting a phase of the input voltage of the dimmer, and thereby on-off or brightness of the light-emitting body c is adjusted. Furthermore, the dimmer may be compatible with a general-purpose LED bulb lamp or a halogen lamp below 42 W in the market. The dimmer of this embodiment may adopt a Triac dimmer, a PWM dimmer, or a power supply control device constituted by electronic components having dimmer functions such as an MOS transistor or an IGBT transistor and the like, as needed.

Further, to meet the requirement for manual adjustment of the brightness of the light-emitting body c, the microprocessor 3 of this embodiment is further connected with a first code switch 4 for controlling the microprocessor 3 to output a PWM modulated signal to the dimmer. In this way, the brightness can be adjusted by directly operating the first code switch 4.

To achieve the punctual on-off function of the light-emitting body c, the microprocessor 3 of this embodiment is further connected with a clock module 5 for controlling the dimmer to be turned on/off on time by means of the microprocessor 3.

To enrich the functions of the whole system, an existing player or radio receiver can be integrated into the control system to meet people's actual use demands and to reduce acquisition cost of separate devices. An output end of the microprocessor 3 of this embodiment is connected with a Bluetooth speaker 7 through an audio amplifier 6, and an input end thereof is connected with an FM radio receiver 8. In this way, audio frequency or control can be achieved through the mobile device by means of coordination of the microprocessor 3 and cooperation of the Bluetooth speaker 7.

Further, the microprocessor 3 of this embodiment is also connected with a second code switch 9 for controlling volume level of the Bluetooth speaker 7 by the microprocessor 3. In this way, the manual adjustment of the volume level can be achieved, thereby meeting use requirements of users.

In addition, to display information (for example, brightness level, volume level, control mode and so on) of the control system in real time, the microprocessor 3 of this embodiment is further connected with a display screen 10, which can be an LED display screen or an LCD display screen and the like according to specific conditions.

Based on the above control system, this embodiment further provides a control method for a wireless lamp, which includes the following steps:

Step I, a wireless pairing connection with the mobile device a is conducted through the wireless module 1.

Step II, after recognizing a signal indicating successful pairing between the wireless module 1 and the mobile device a, the microprocessor 3 can output a corresponding signal to control the power supply module 2 to be turned on, thereby achieving an automatic control of on-off of the light-emitting body c. If no signal indicating the successful pairing is recognized, the power off state of the power supply module 2 is maintained so that the light-emitting body c is in an off state.

Further, an APP can be embedded into the mobile device a in advance, and the microprocessor 3 receives a control instruction issued by the APP through the wireless module 1 and synchronously uploads data gathered by the microprocessor 3 to the APP. Meanwhile, corresponding status information (power consumption of the whole system and usage statuses of various functions, etc.) of the control system can be acquired by using the APP to display on the mobile device a.

Preferably, the mobile device a of this embodiment is a smart mobile phone, a tablet computer, a smart wearable device (for example, a smart watch) or other smart control devices having a wireless connection functions such as Bluetooth or WIFI.

The above are merely preferred embodiments of the present disclosure and are not intended to limit the patent scope of the present disclosure. Any modifications of equivalent structure or equivalent process made on the basis of the contents of the description and accompanying drawings of the present disclosure or directly or indirectly applied to other related technical fields shall fall within the scope of patent protection of the present disclosure.

What is claimed is:

1. A control system for a wireless lamp, characterized by comprising: a wireless module for wireless pairing connection with a mobile device, a power supply module connected between a power source and a light-emitting body, and a microprocessor for recognizing a signal input by the wireless module and controlling the power supply module to be turned on or off; the wireless module and the power supply module are respectively connected to the microprocessor, and the wireless module is a Bluetooth module or a WIFI module.

2. The control system for a wireless lamp according to claim 1, characterized in that the power supply module is a dimmer.

3. The control system for a wireless lamp according to claim 2, characterized in that the microprocessor is further connected with a first code switch for controlling the microprocessor to output a PWM modulated signal to the dimmer.

4. The control system for a wireless lamp according to claim 2, characterized in that the microprocessor is further connected with a clock module for controlling the dimmer to be turned on/off on time through the microprocessor.

5. The control system for a wireless lamp according to claim 2, characterized in that an output end of the microprocessor is connected with a Bluetooth speaker through an audio amplifier, and an input end thereof is connected with an FM radio receiver.

6. The control system for a wireless lamp according to claim 5, characterized in that the microprocessor is further connected with a second code switch for controlling volume level of the Bluetooth speaker through the microprocessor.

7. The control system for a wireless lamp according to any one of claims 1-6, characterized in that the microprocessor is further connected with a display screen.

8. A control method for a wireless lamp, characterized by comprising:
Step I, conducting a wireless pairing connection with a mobile device through a wireless module; and
Step II, after recognizing a signal indicating successful pairing of the wireless module, controlling, by the microprocessor, a power supply module to be turned on, otherwise, controlling, the power supply module to be turned off.

9. The control method for a wireless lamp according to claim 8, characterized in that an APP is embedded into the mobile device in advance, and the microprocessor receives a control instruction issued by the APP through the wireless module and synchronously uploads data information.

10. The control method for a wireless lamp according to claim 9, characterized in that the mobile device is a smart mobile phone, a tablet computer or a smart wearable device.
